(19) United States
(12) Patent Application Publication
(10) Pub. No.: US 2025/0214292 A1
(43) Pub. Date: Jul. 3, 2025

(54) MOLDING CONDITION SETTING METHOD

(71) Applicant: SEIKO EPSON CORPORATION, Tokyo (JP)

(72) Inventor: Masashi FUCHII, Minowa-machi (JP)

(21) Appl. No.: 19/000,765

(22) Filed: Dec. 24, 2024

(30) Foreign Application Priority Data
Dec. 27, 2023 (JP) 2023-220424

(51) Int. Cl. B29C 45/76

(52) U.S. Cl. CPC B29C 45/766; B29C 2945/7614; B29C 2945/76183; B29C 2945/76531; B29C 2945/76625

(57) ABSTRACT

A molding condition setting method for an injection molding machine that molds a molded article includes: (a) adjusting a temperature and humidity around the injection molding machine; (b) acquiring a moisture content of a material used for molding the molded article; (c) setting a plurality of molding conditions for the molded article to be molded by the injection molding machine; (d) molding the molded article under the plurality of molding conditions by the injection molding machine injecting a plasticized material obtained by plasticizing the material into a mold under an environmental condition including the temperature and the humidity adjusted in (a) and the moisture content acquired in (b); and (e) determining an optimum condition in the molding conditions under the environmental condition based on quality of the molded article molded in (d). In (a), the temperature is adjusted to a temperature of a place where the molded article is to be produced, and the humidity is adjusted to humidity of the place where the molded article is to be produced.

The present application is based on, and claims priority from JP Application Serial Number 2023-220424, filed Dec. 27, 2023, the disclosure of which is hereby incorporated by reference herein in its entirety.

### BACKGROUND

### 1. Technical Field

The present disclosure relates to a molding condition setting method.

### 2. Related Art

JP-A-10-272663 discloses a molding condition optimizing method for an injection molding machine, which involves conducting a trial molding test under a good product molding condition to measure a range of fluctuations in a molding variable caused by environmental changes, and creating an updated molding condition by correcting the molding variable based on the measured range of fluctuations.

Optimum molding conditions for molding a molded article vary depending on environmental conditions, including a temperature and humidity around an injection molding machine. Therefore, there is a demand for a technique for determining an optimum molding condition under an environmental condition of a place where the molded article is produced.

### SUMMARY

According to a first aspect of the present disclosure, a molding condition setting method for an injection molding machine that molds a molded article is provided. The molding condition setting method includes: (a) adjusting a temperature and humidity around the injection molding machine; (b) acquiring a moisture content of a material used for molding the molded article; (c) setting a plurality of molding conditions for the molded article to be molded by the injection molding machine; (d) molding the molded article under the plurality of molding conditions by the injection molding machine injecting a plasticized material obtained by plasticizing the material into a mold under an environmental condition including the temperature and the humidity adjusted in (a) and the moisture content acquired in (b); and (e) determining an optimum condition in the molding conditions under the environmental condition based on quality of the molded article molded in (d). In (a), the temperature is adjusted to a temperature of a place where the molded article is to be produced, and the humidity is adjusted to humidity of the place where the molded article is to be produced.

### BRIEF DESCRIPTION OF THE DRAWINGS

FIG. 1 is a diagram showing a schematic configuration of a molding condition setting system.

FIG. 2 is a diagram showing a schematic configuration of a control device.

FIG. 3 is a perspective view of each unit with a cover removed.

FIG. 4 is a cross-sectional view showing a schematic configuration of an injection molding machine.

FIG. 5 is a perspective view showing a schematic configuration of a screw.

FIG. 6 is a schematic plan view of a barrel.

FIG. 7 is a process diagram of molding condition setting processing.

FIG. 8 is a process diagram of optimum condition determination processing.

FIG. 9 is a diagram showing an example of a change in effective value over time.

FIG. 10 is a process diagram of molded article production processing.

### DESCRIPTION OF EMBODIMENTS

### A. First Embodiment

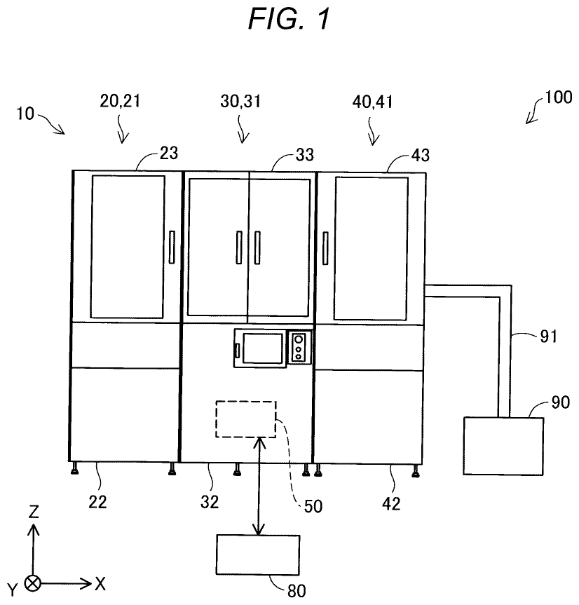

FIG. 1 is a diagram showing a schematic configuration of a molding condition setting system 100. FIG. 1 shows arrows indicating X, Y, and Z directions perpendicular to one another. The X direction and the Y direction are parallel to a horizontal plane. The Z direction is a direction parallel to a vertical direction. The X, Y, and Z directions in FIG. 1 and the X, Y, and Z directions in the other figures indicate the same directions. To specify an orientation, a positive or negative sign is added to the description of the direction, where “+” refers to a positive direction that is a direction indicated by an arrow, and “−” refers to a negative direction that is an opposite direction of the direction indicated by the arrow. The molding condition setting system 100 includes an injection molding system 10, a control device 80, and a thermo-hygrostat 90.

The injection molding system 10 includes a material supply unit 20, an injection molding unit 30, an inspection storage unit 40, and a controller 50. The material supply unit 20, the injection molding unit 30, and the inspection storage unit 40 are disposed in this order from a −X direction to a +X direction. Each of the units is detachably connected to another adjacent unit. Each of the units has a box-shaped housing, and one or more devices, members, and the like are integrated in the housing to form a single unit. Hereinafter, the housing of the material supply unit 20 is referred to as a first housing 21, the housing of the injection molding unit 30 is referred to as a second housing 31, and the housing of the inspection storage unit 40 is referred to as a third housing 41. The first housing 21 includes a first base 22 and a first cover 23 covering an upper surface of the first base 22. The second housing 31 includes a second base 32 and a second cover 33 covering an upper surface of the second base 32. The third housing 41 includes a third base 42 and a third cover 43 covering an upper surface of the third base 42. The first cover 23, the second cover 33, and the third cover 43 are provided such that spaces inside the respective covers communicate with each other. Hereinafter, the first cover 23, the second cover 33, and the third cover 43 are collectively referred to as a cover.

The controller 50 is provided in the second base 32. The controller 50 is implemented by a programmable logic controller (PLC). The controller 50 is programmed in a language such as a ladder language to control coordinated operations of various devices provided in each unit. The controller 50 is coupled to the control device 80.

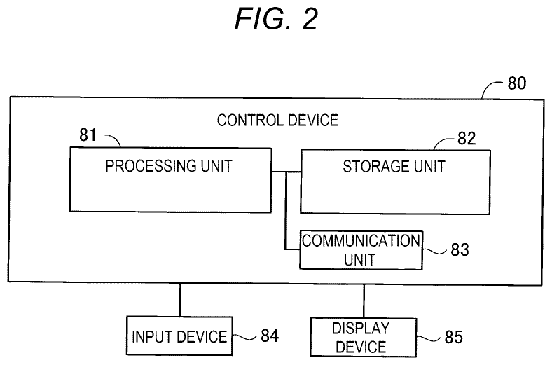

FIG. 2 is a diagram showing a schematic configuration of the control device 80. The control device 80 is implemented by a computer including a processing unit 81, a storage unit 82, and a communication unit 83. The processing unit 81 includes one or more processors. The processing unit 81 controls an operation of the respective units of the injection molding system 10 by executing a program stored in the storage unit 82. The storage unit 82 includes a main storage device such as a RAM and an auxiliary storage device such as a hard disk drive. The control device 80 may be implemented by a configuration in which a plurality of circuits to implement at least a part of the respective functions are combined together, instead of being implemented by a computer. An input device 84 such as a keyboard and a mouse and a display device 85 such as a liquid crystal display are coupled to the control device 80. The input device 84 and the display device 85 may be integrated as a touch panel. The control device 80 may be a server. The control device 80 may include a plurality of computers. The control device 80 may include, for example, one computer and a plurality of servers.

The thermo-hygrostat 90 is coupled to an inside of the cover by a duct 91. The thermo-hygrostat 90 adjusts a temperature and humidity inside the cover.

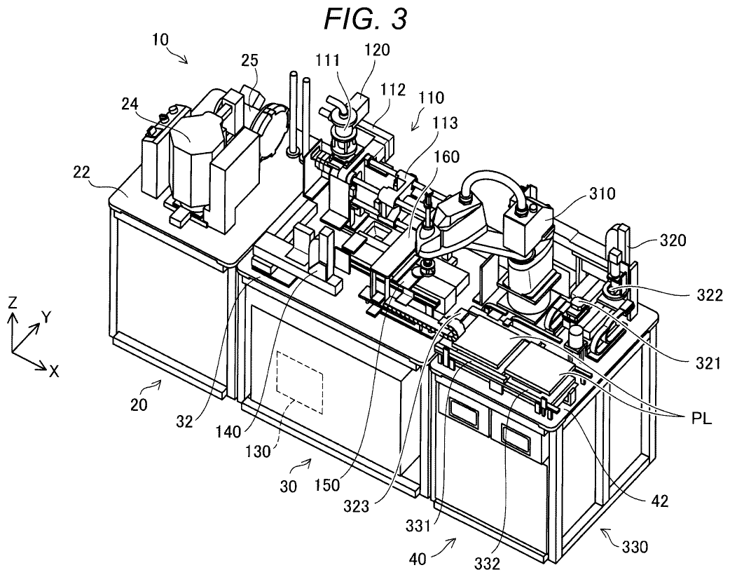

FIG. 3 is a perspective view of each unit with the cover removed.

The material supply unit 20 includes a material dryer 24 and a material supply section 25. The material dryer 24 stores a material used for molding a molded article. The material stored in the material dryer 24 is dehumidified and dried in the material dryer 24. As the material, thermoplastic resin such as polypropylene resin (PP), polyethylene resin (PE), or polyacetal resin (POM) is used. The material supply section 25 is a loader including a conveyor that conveys a material. The material in the material dryer 24 is supplied from the material supply section 25 to a hopper 111 of an injection molding machine 110 in the injection molding unit 30.

The injection molding unit 30 includes the injection molding machine 110, a spectrometer 120, a mold temperature regulator 130, a removal device 140, a transport device 150, and a gate cutting device 160. The injection molding machine 110, the spectrometer 120, the removal device 140, the transport device 150, and the gate cutting device 160 are disposed on the second base 32. The mold temperature regulator 130 is accommodated in the second base 32.

The injection molding machine 110 is configured such that a mold can be attached thereto. The injection molding machine 110 includes the hopper 111, an injection unit 112, and a mold clamping unit 113. The material supplied from the material supply section 25 is stored in the hopper 111. The hopper 111 is preferably made of a material that transmits infrared rays. The injection unit 112 plasticizes the material supplied from the hopper 111 to generate a plasticized material, and injects the generated plasticized material into a cavity of the mold. The mold clamping unit 113 opens and closes a mold attached to the injection molding machine 110. The injection unit 112 and the mold clamping unit 113 are disposed in a horizontal direction.

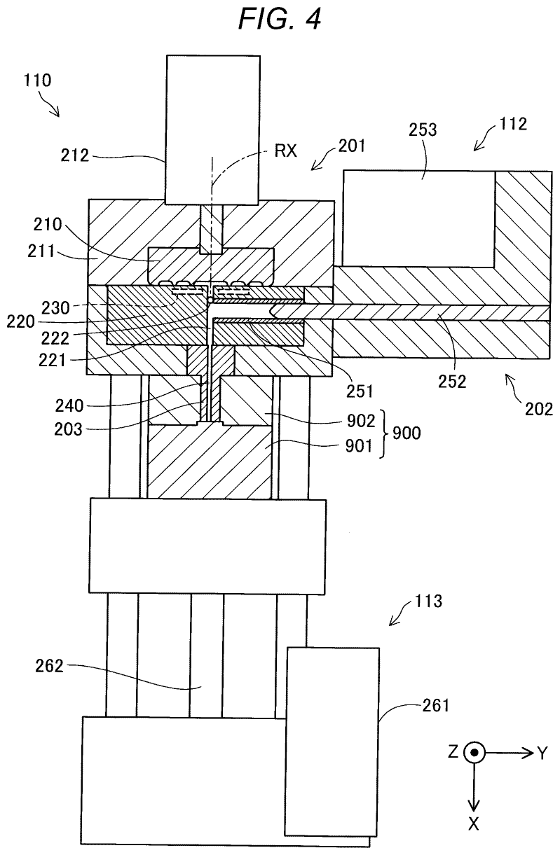

FIG. 4 is a cross-sectional view showing a schematic configuration of the injection molding machine 110. The injection unit 112 includes a plasticizing unit 201, a suction feeding unit 202, and a nozzle 203.

The plasticizing unit 201 plasticizes at least a part of the material supplied from the hopper 111 and thus generates a plasticized material. The term “plasticizing” used herein is a concept including melting and means changing a solid state to a flowable state. Specifically, in a case of a material that experiences glass transition, plasticizing means raising the temperature of the material to a temperature equal to or higher than a glass transition point. In a case of a material that does not experience glass transition, plasticizing means setting the temperature of the material to be equal to or higher than a melting point. The plasticizing unit 201 includes a screw 210, a barrel 220, and a heater 230.

The screw 210 is accommodated in a screw case 211. The screw 210 is coupled to a drive motor 212, and rotates in the screw case 211 by rotational drive force generated by the drive motor 212. An axial direction of a rotation axis RX of the screw 210 is a direction along the X direction. A rotational speed of the screw 210 is controlled by the controller 50 controlling a rotational speed of the drive motor 212. The screw 210 may be driven by the drive motor 212 via a speed reducer. The screw 210 is also called a rotor or a flat screw.

The barrel 220 is disposed at a +X direction side of the screw 210. A communication hole 221 is formed at a center of the barrel 220. The communication hole 221 forms at least a part of a flow path 240 through which the plasticized material flows. An injection cylinder 251, described later, is coupled to the communication hole 221. The communication hole 221 is provided with a check valve 222 upstream from the injection cylinder 251. The heater 230 is provided in the barrel 220. A temperature of the heater 230 is controlled by the controller 50.

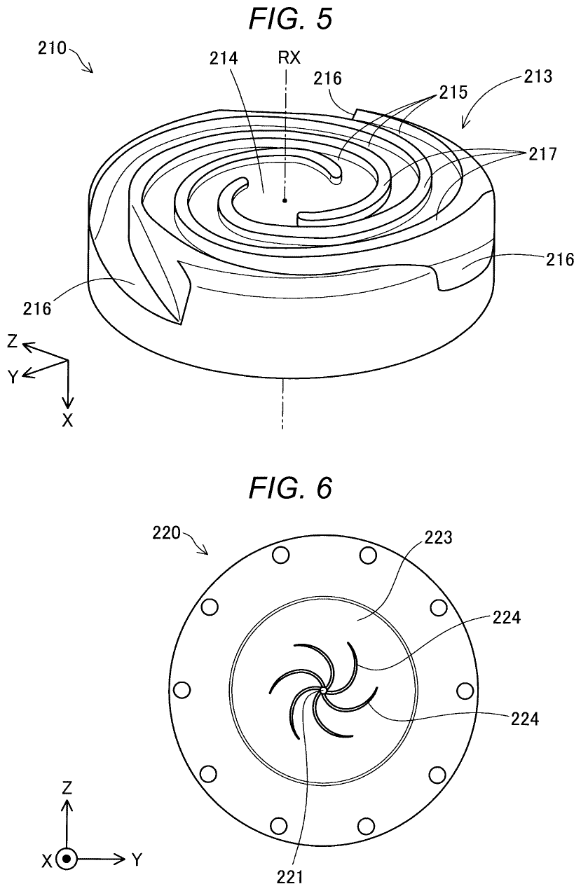

FIG. 5 is a perspective view showing a schematic configuration of the screw 210. The screw 210 has substantially columnar shape having a length in a direction along the rotation axis RX smaller than a length of the screw 210 in a direction perpendicular to the rotation axis RX. At a groove forming surface 213 facing the barrel 220, of the screw 210, vortex-shaped grooves 215 are formed about a center part 214. The grooves 215 communicate with material loading ports 216 formed in a side surface of the screw 210. The material supplied from the hopper 111 is supplied, via the material loading port 216, to the groove 215. The grooves 215 are formed by being separated by protruding part 217. FIG. 5 shows a case where three grooves 215 are formed, and the number of grooves 215 may be one or may be two or more. The grooves 215 do not necessarily have vortex shapes and may have spiral shapes or shapes of involute curves, or may have shapes extending arcuately from the center part 214 toward an outer circumference.

FIG. 6 is a schematic plan view of the barrel 220. The barrel 220 has an opposite surface 223 facing the groove forming surface 213 of the screw 210. The communication hole 221 is formed at a center of the opposite surface 223. At the opposite surface 223, a plurality of guide grooves 224 coupled to the communication hole 221 and extending in a shape of a vortex from the communication hole 221 toward the outer circumference are formed. The material supplied to the groove 215 of the screw 210 flows along the grooves 215 and the guide grooves 224 due to rotation of the screw 210 and is guided to the center part 214 of the screw 210, while being plasticized between the screw 210 and the barrel 220 due to the rotation of the screw 210 and heating by the heater 230. The material flowing in the center part 214 flows out to the suction feeding unit 202 from the communication hole 221 formed at the center of the barrel 220. The barrel 220 may be not provided with the guide grooves 224. The guide grooves 224 may be not coupled to the communication hole 221.

The suction feeding unit 202 includes the injection cylinder 251, a plunger 252, and a plunger drive unit 253. The suction feeding unit 202 has a function of injecting the plasticized material in the injection cylinder 251 into the cavity of the mold 900. The suction feeding unit 202 controls an injection amount, injection speed, and injection pressure of the plasticized material injected from the nozzle 203 under control of the controller 50. The injection cylinder 251 is a substantially cylindrical member coupled to the communication hole 221 of the barrel 220 and has the plunger 252 inside. The plunger 252 slides inside the injection cylinder 251, and pressure-feeds the plasticized material in the injection cylinder 251 to the nozzle 203. The plunger 252 is driven by the plunger drive unit 253 implemented by a motor.

The flow path 240 is formed in the nozzle 203. When the plunger 252 pressure-feeds the plasticized material in the injection 251 to the nozzle 203, the plasticized material is injected from the nozzle 203 to the mold 900.

The mold clamping unit 113 opens and closes the mold 900 attached to the injection molding machine 110. The mold clamping unit 113 drives a motor 261 under control of the controller 50 to rotate a ball screw 262 and moves a movable mold 901 coupled to the ball screw 262 relative to a fixed mold 902, thereby opening and closing the mold 900.

The spectrometer 120 shown in FIG. 3 is provided in the hopper 111. The spectrometer 120 measures a moisture content of the material stored in the hopper 111. The spectrometer 120 measures the moisture content of the material by, for example, irradiating the material in the hopper 111 with near-infrared light and measuring light that is reflected without being absorbed by the material.

The mold temperature regulator 130 circulates a heat medium through a cooling pipe provided in the mold 900 to adjust a temperature of the mold 900.

The removal device 140 is a device that removes a molded article molded by the injection molding machine 110 from the injection molding machine 110. The removal device 140 is disposed on a −Y direction side of the injection molding machine 110. The removal device 140 includes a hand that grips the molded article and a linear actuator that moves the hand along the X direction and the Y direction. The removal device 140 uses the hand to remove the molded article from the injection molding machine 110, and uses the linear actuator to move the molded article removed from the injection molding machine 110 to an end portion of the transport device 150 on a −X direction side, and places the molded article on the transport device 150.

The transport device 150 is a device that transports the molded article removed by the removal device 140. The transport device 150 is disposed on the −Y direction side of the injection molding machine 110 and on a +X direction side of the removal device 140. The transport device 150 is implemented by a linear actuator capable of moving a molded article along the X direction. The transport device 150 moves the molded article placed on the transport device 150 by the removal device 140 toward an end portion on the +X direction side from the end portion on the −X direction side. A gate cutting device 160 that cuts off a gate portion and a runner remaining on the molded article is disposed on the transport device 150. The gate cutting device 160 cuts off the gate portion and the runner of the molded article being transported on the transport device 150 during transport.

The inspection storage unit 40 includes a robot 310, an inspection device 320, and a stacking mechanism 330.

The robot 310 is a device that moves the molded article transported by the transport device 150. The robot 310 is implemented as a SCARA robot. The robot 310 holds the molded article that is transported by the transport device 150 to the end portion of the transport device 150 on the +X direction side, and moves the molded article to the inspection device 320. The robot 310 moves the molded article that completes inspection by the inspection device 320 to a pallet PL of the stacking mechanism 330. The robot 310 is not limited to the SCARA robot, and may be implemented by a vertical articulated robot having a plurality of axes.

The inspection device 320 inspects a molded article molded by the injection molding machine 110. The inspection device 320 includes an inspection table 321 on which a molded article is placed, an imaging unit 322 that captures an image of the molded article placed on the inspection table 321, and a weight measurement unit 323 that measures a weight of the molded article.

The imaging unit 322 is a camera including an imaging element such as a charge coupled device (CCD) sensor or a complementary metal oxide semiconductor (CMOS) sensor, and also includes an illumination unit. The inspection device 320 images the molded article on the inspection table 321 using the imaging unit 322, analyzes the captured image, and performs an inspection on appearance including a shape of the molded article. After the inspection on appearance ends, the molded article is moved to the weight measurement unit 323 by the robot 310.

The weight measurement unit 323 is implemented by a weight sensor such as a load cell. The inspection device 320 measures a weight of the molded article placed on the weight measurement unit 323. After the inspection, the molded article is moved to the pallet PL by the robot 310. The molded article determined as a defective product by the inspection device 320 is discharged to a defective product discharge area (not shown) by the robot 310.

The stacking mechanism 330 is a mechanism for stacking pallets PL on which molded articles are placed. The stacking mechanism 330 includes a first disposition portion 331 and a second disposition portion 332. The pallets PL are disposed in the first disposition portion 331 and the second disposition portion 332. The first disposition portion 331 mounts the pallet PL on which a plurality of molded articles inspected by the inspection device 320 are disposed. The robot 310 conveys the molded article to the pallet PL mounted on the first disposition portion 331. When a predetermined number of molded articles are disposed on the pallet PL, the first disposition portion 331 lowers the pallet PL to an inside of the second housing 31. The second disposition portion 332 slides and moves the pallet PL placed on an uppermost portion of the second disposition portion 332 onto the pallet PL of the lowered first disposition portion 331. A plurality of pallets PL are stacked in the vertical direction in the second disposition portion 332. When the pallet PL on the uppermost portion is moved to the first disposition portion 331, the second disposition portion 332 raises the remaining pallets PL.

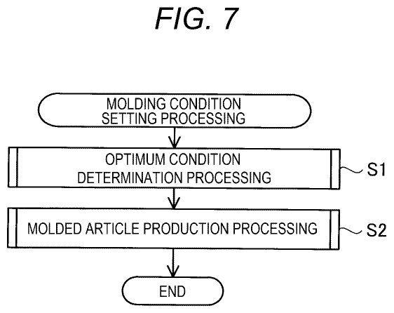

FIG. 7 is a process diagram of molding condition setting processing. The molding condition setting processing implements a molding condition setting method for the injection molding machine 110 that molds a molded article. In the molding condition setting processing, first, optimum condition determination processing is executed in step S1, and then molded article production processing is executed in step S2.

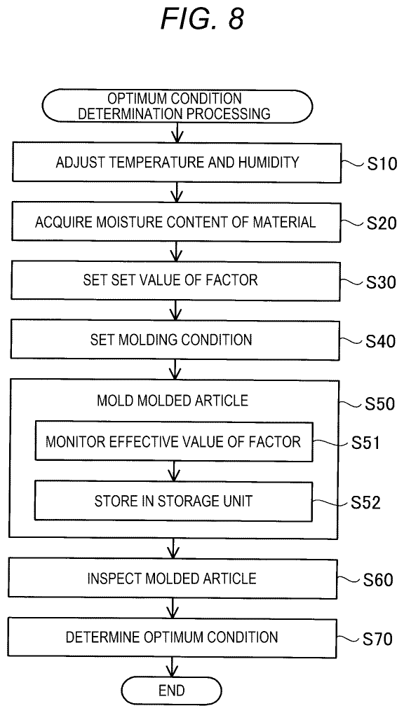

FIG. 8 is a process diagram of the optimum condition determination processing. First, in step S10, the thermo-hygrostat 90 adjusts a temperature inside the cover to a temperature of a place where the molded article is produced, and adjusts humidity inside the cover to humidity of the place where the molded article is produced. That is, the thermo-hygrostat 90 adjusts a temperature around the injection molding machine 110 to the temperature of the place where the molded article is produced, and adjusts humidity around the injection molding machine 110 to the humidity of the place where the molded article is produced. Here, the place where the molded article is produced is, for example, a factory where the molded article is produced using an injection molding machine, or a destination where the injection molding machine is shipped or rented.

In step S20, the spectrometer 120 acquires a moisture content of the material stored in the hopper 111. Hereinafter, the temperature around the injection molding machine 110, the humidity around the injection molding machine 110, and the moisture content of the material are collectively referred to as environmental conditions.

In step S30, the control device 80 sets a set value of a factor related to molding of the molded article. The factors include a temperature of the mold 900, a temperature of the plasticized material, a pressure of the plasticized material, an injection speed of the plasticized material, and a cooling time of the mold 900. Here, the cooling time of the mold 900 is a time taken for the mold 900 to cool after the mold 900 is filled with the plasticized material. The control device 80 may set a value input to the control device 80 by a user via the input device 84 as the set value of the factor, or may set a predetermined value as the set value of the factor. Hereinafter, the set value of the factor is simply referred to as a set value.

In step S40, the control device 80 sets a plurality of molding conditions for the molded article to be molded by the injection molding machine 110. The molding conditions have a plurality of parameters, such as barrel temperature, injection pressure, pressure holding time, and screw rotation speed. The control device 80 sets the molding conditions such that an effective value of the factor in molding the molded article is close to the set value set in step $30. Here, the effective value of the factor means an actual value of the factor in molding the molded article. Hereinafter, the effective value of the factor is simply referred to as an effective value. For example, the temperature of the plasticized material varies depending on the barrel temperature. The control device 80 sets the barrel temperature such that an effective value of the temperature of the plasticized material in molding the molded article is close to a set value. The pressure of the plasticized material and the injection speed of the plasticized material vary depending on the injection pressure and the pressure holding time. Here, the injection pressure is a pressure with which the plunger 252 pushes out the plasticized material toward the nozzle 203. The control device 80 sets the injection pressure and the pressure holding time such that an effective value of the pressure of the plasticized material in molding the molded article is close to a set value. The control device 80 sets the injection pressure and the pressure holding time such that an effective value of the injection speed of the plasticized material in molding the molded article is close to a set value.

In step S40, the control device 80 sets a first molding condition and a second molding condition in which a first parameter, which is a parameter in the first molding condition, is different from that of the first molding condition. The first parameter may be a parameter determined by the control device 80 or a parameter designated by the user operating the input device 84. For example, when the first parameter is the barrel temperature and the barrel temperature in the first molding condition is 200° C., the control device 80 sets the barrel temperature in the second molding condition to 210° C. The first parameter is not limited to one parameter, and may be a plurality of parameters. The control device 80 may set a plurality of different molding conditions including the first molding condition and the second molding condition, rather than being limited to the first molding condition and the second molding condition.

In step S50, the injection molding machine 110 injects the plasticized material into the mold 900 under the environmental conditions including the temperature and humidity adjusted in step S10 and the moisture content of the material acquired in step S20, thereby molding a molded article under the plurality of molding conditions set in step S40. That is, the injection molding machine 110 molds the molded article under the first molding condition and the second molding condition. Hereinafter, a molded article molded under the first molding condition is referred to as a first molded article, and a molded article molded under the second molding condition is referred to as a second molded article.

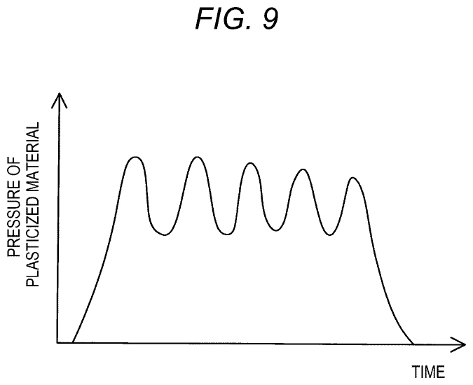

In step S50, steps S51 and S52 are executed. In step S51, the control device 80 monitors the effective value of the factor during a period in which the molded article is molded. FIG. 9 is a diagram showing an example of a change in effective value over time. In FIG. 9, a horizontal axis indicates an elapsed time, and a vertical axis indicates an effective value of the pressure of the plasticized material. FIG. 9 shows a change in effective value of the pressure of the plasticized material over time.

In step S52, the control device 80 stores, in the storage unit 82, first information in which environmental conditions under which the molded article is molded, molding conditions used for molding the molded article, and effective values when the molded article is molded are associated with one another. In other words, the first information is information in which the environmental conditions including the temperature and humidity adjusted in step S10 and the moisture content of the material acquired in step S20, the molding condition set in step S40, and the effective value when the molded article is molded under the molding condition under the environmental conditions are associated with one another.

In step S60, the inspection device 320 inspects the molded article molded in step S50.

In step S70, the control device 80 determines, based on quality of the molded article molded in step S50, an optimum condition in the molding condition under the environmental conditions including the temperature and humidity adjusted in step S10 and the moisture content of the material acquired in step S20. The control device 80 determines, as the optimum condition, a molding condition under which the molded article having the best quality is molded among the molding conditions set in step S40. The molded article having the best quality is, for example, a molded article having no defects in appearance and having a dimension and a weight closest to a standard value of the dimension and a standard value of the weight of the molded article, respectively. In other words, the control device 80 selects the optimum condition from the first molding condition and the second molding condition according to a comparison result between the first molded article and the second molded article. The control device 80 determines, as the optimum condition, a molding condition under which a molded article having better quality is molded, from the first molding condition and the second molding condition. As described above, the optimum condition determination processing is executed.

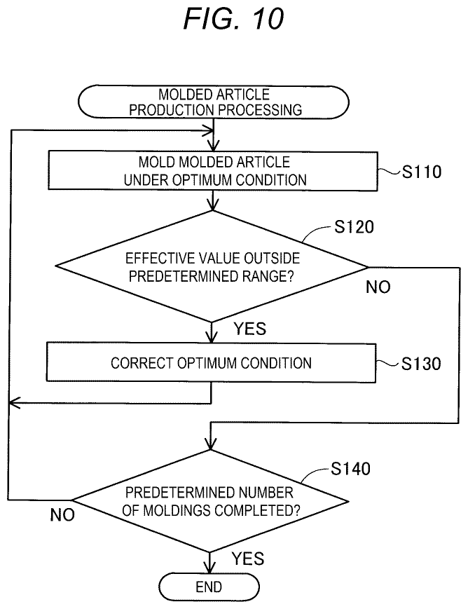

FIG. 10 is a process diagram of molded article production processing. The molded article production processing is executed at the “place where the molded article is produced” described in step S10 in the optimum condition determination processing. As described in step S10, the temperature and humidity of the place where the molded article is produced are the same as the temperature and humidity around the injection molding machine 110 adjusted in step S10, respectively. The molding condition setting system used in the molded article production processing may be a system that does not include the thermo-hygrostat 90 and the cover. The injection molding machine used in the molded article production processing may be the same injection molding machine as the injection molding machine 110 used in the optimum condition determination processing, or may be another injection molding machine.

In step S110, the injection molding machine 110 molds a molded article under an environmental condition including the temperature and humidity adjusted in step S10 and the moisture content of the material acquired in step S20 in the optimum condition determination processing under the optimum condition determined in step S70. The moisture content in the material stored in the hopper 111 of the injection molding machine 110 is the same as the moisture content acquired in step S20. When the moisture content in the material stored in the hopper 111 is different from the moisture content acquired in step S20, the material dryer 24 dries the material such that the moisture contents are equal.

In step S120, the control device 80 determines whether the effective value of the factor varies outside a predetermined range. When the effective value varies outside the predetermined range, step $130 is executed. When the effective value does not vary outside the predetermined range, step S140 is executed. The control device 80 may determine whether an abnormality appears in a waveform of the graph showing the change in the effective value over time as shown in FIG. 9, execute step S130 when an abnormality appears, and execute step S140 when there is no abnormality.

In step S130, the control device 80 corrects the optimum condition based on the first information. For example, when the temperature of the plasticized material, which is one of the factors, falls below a predetermined lower limit value, the control device 80 corrects the barrel temperature for the optimum condition so that the temperature of the plasticized material is increased. The control device 80 corrects the barrel temperature for the optimum condition to a value obtained by multiplying the barrel temperature for the optimum condition by a coefficient. The above-described coefficient is a value calculated based on a relationship between the effective value of the temperature of the plasticized material and the barrel temperature in the first information, and by multiplying the above-described coefficient by the barrel temperature for the optimum condition, the temperature of the plasticized material exceeds a predetermined lower limit value. After step S130 is executed, step S110 is executed. Accordingly, the molded article is molded under the optimum condition after the correction.

In step S140, the control device 80 determines whether a predetermined number of molded articles are molded. When a predetermined number of molded articles are molded, the control device 80 ends the molded article production processing. When the predetermined number of molded articles are not molded, the control device 80 returns the processing to step S110. As described above, the molded article production processing is executed.

According to the first embodiment described above, a molded article is molded under a plurality of molding conditions under an environmental condition of a place where the molded article is produced, and an optimum condition in the molding conditions is determined based on quality of the molded article. Here, the environmental condition of the place where the molded article is produced is reproduced by adjusting the temperature and humidity around the injection molding machine 110 to the temperature and humidity of the place where the molded article is produced, respectively. Therefore, it is possible to determine an optimum molding condition under the environmental condition of the place where the molded article is produced. Since it is possible to determine the optimum condition at the place where the molded article is produced in a place with a different temperature and humidity from the place where the molded article is produced, it is not necessary to investigate the optimum condition at the place where the molded article is produced. Further, even when the temperature and humidity of the place where the molded article is produced change depending on a season, the optimum condition according to the season can be determined.

In the embodiment, the optimum condition is selected from the first molding condition and the second molding condition according to the comparison result between the first molded article and the second molded article. Therefore, from the first molding condition and the second molding condition, the molding condition under which a molded article having better quality is molded can be determined as the optimum condition.

In the embodiment, the moisture content of the material used for molding the molded article is measured by the spectrometer 120. Therefore, the moisture content of the material can be measured from an outside of a portion where the material is stored.

In the embodiment, the spectrometer 120 is disposed in the hopper 111 in which the material is stored. Therefore, the moisture content of the material immediately before being used to mold the molded article can be measured.

In the embodiment, the molding conditions are set such that the effective value of the factor in molding the molded article is close to the set value. Therefore, a range of molding conditions that can be set can be narrowed as compared with a case where there is no limitation on setting of molding conditions. Accordingly, the number of molding conditions to be set can be reduced, and a time required for determining the optimum condition can be shortened.

In the embodiment, in molding the molded article, the first information including the environmental condition, the molding condition, and the effective value when the molded article is molded under the molding condition under the environmental condition is stored in the storage unit 82. Therefore, the user can check the first information after the molded article is molded.

In the embodiment, in molding a molded article by the injection molding machine 110 under the optimum condition, when the effective value varies outside the predetermined range, the optimum condition is corrected based on the first information. Therefore, when the quality of the molded article deteriorates during molding the molded article under the optimum condition, the quality of the molded article can be improved.

### B. Other Embodiments

(B-1) In the embodiment, the moisture content of the material used for molding is measured by the spectrometer 120. In contrast, the moisture content of the material used for molding may be measured by a device other than the spectrometer.

(B-2) In the embodiment, the spectrometer 120 is disposed in the hopper 111 in which the material is stored. In contrast, the spectrometer 120 is not limited to being disposed in the hopper 111, and may be disposed at a position where the moisture content of the material can be measured.

(B-3) In the embodiment, the set value of the factor is set in step S30 in the optimum condition determination processing, and the molding condition is set in step S40 such that the effective value of the factor in molding the molded article is close to the set value. In contrast, the set value of the factor may not be set in the optimum condition determination processing. That is, step S30 in the optimum condition determination processing may not be executed.

(B-4) In the embodiment, the factors include the temperature of the mold 900, the temperature of the plasticized material, the pressure of the plasticized material, the injection speed of the plasticized material, and the cooling time of the mold 900. In contrast, the factor may include at least one of the temperature of the mold 900, the temperature of the plasticized material, the pressure of the plasticized material, the injection speed of the plasticized material, and the cooling time of the mold 900.

(B-5) In the embodiment, in step S52 in the optimum condition determination processing, the first information including the environmental condition, the molding condition, and the effective value when the molded article is molded under the molding condition under the environmental condition is stored in the storage unit 82.

In contrast, the first information may not be stored in the storage unit 82 in molding the molded article. That is, step S52 in the optimum condition determination processing may not be executed.

(B-6) In the embodiment, the molded article production processing is executed in the molding condition setting processing. In contrast, the molded article production processing may not be executed.

### C. Other Aspects

The present disclosure is not limited to the embodiments described above, and can be implemented in various aspects to the extent that the various aspects do not depart from the intent of the present disclosure. For example, the present disclosure can also be implemented in the following aspects. To solve some or all of the problems described in the present disclosure, or to achieve some or all of the effects of the present disclosure, technical features of the embodiments described above that correspond to the technical features in each of the following aspects can be replaced or combined as appropriate. The technical features can be deleted as appropriate unless described as essential technical features in the present specification.
(1) According to an aspect of the present disclosure, a molding condition setting method for an injection molding machine that molds a molded article is provided. The molding condition setting method includes: (a) adjusting a temperature and humidity around the injection molding machine; (b) acquiring a moisture content of a material used for molding the molded article; (c) setting a plurality of molding conditions for the molded article to be molded by the injection molding machine; (d) molding the molded article under the plurality of molding conditions by the injection molding machine injecting a plasticized material obtained by plasticizing the material into a mold under an environmental condition including the temperature and the humidity adjusted in (a) and the moisture content acquired in (b); and (e) determining an optimum condition in the molding conditions under the environmental condition based on quality of the molded article molded in (d). In (a), the temperature is adjusted to a temperature of a place where the molded article is to be produced, and the humidity is adjusted to humidity of the place where the molded article is to be produced.

According to such an aspect, it is possible to determine an optimum molding condition under the environmental condition of the place where the molded article is produced.
(2) In the aspect, in (c), a first molding condition and a second molding condition in which a first parameter, which is a parameter in the first molding condition, is different from that of the first molding condition may be set, and (d) may include the injection molding machine molding a first molded article under the first molding condition, and the injection molding machine molding a second molded article under the second molding condition, and in (e), the optimum condition may be selected from the first molding condition and the second molding condition according to a comparison result between the first molded article and the second molded article.

According to such an aspect, from the first molding condition and the second molding condition, the molding condition under which a molded article having better quality is molded can be determined as the optimum condition.
(3) In the aspect, the moisture content may be measured by a spectrometer in (b).

According to such an aspect, the moisture content of the material can be measured from an outside of a portion where the material is stored.
(4) In the aspect, the spectrometer may be disposed in a hopper in which the material is stored.

According to such an aspect, the moisture content of the material immediately before being used to mold the molded article can be measured.
(5) The aspect may further include (f) setting a set value of a factor that is adjusted according to the environmental condition and that is related to molding of the molded article, in which in (c), each of the molding conditions may be set such that an effective value of the factor in (d) is close to the set value, and the factor may include at least one of a temperature of the mold, a temperature of the plasticized material, a pressure of the plasticized material, an injection speed of the plasticized material, and a cooling time of the mold.

According to such an aspect, a range of molding conditions that can be set can be narrowed as compared with a case where there is no limitation on setting of molding conditions. Accordingly, the number of molding conditions to be set can be reduced, and a time required for determining the optimum condition can be shortened.
(6) In the aspect, the (d) may include monitoring the effective value, and storing, in a storage unit, first information in which the environmental condition, the molding condition, and the effective value when the molded article is molded under the molding condition under the environmental condition are associated with one another.

According to such an aspect, the user can check the first information after the molded article is molded.
(7) The aspect may further include (g) molding the molded article under the optimum condition under the environmental condition by the injection molding machine, in which in (g), the optimum condition may be corrected based on the first information when the effective value varies outside a predetermined range.

According to such an aspect, when the quality of the molded article deteriorates during molding the molded article under the optimum condition, the quality of the molded article can be improved.

What is claimed is:

1. A molding condition setting method for an injection molding machine that molds a molded article, the molding condition setting method comprising:
(a) adjusting a temperature and humidity around the injection molding machine;
(b) acquiring a moisture content of a material used for molding the molded article;
(c) setting a plurality of molding conditions for the molded article to be molded by the injection molding machine;
(d) molding the molded article under the plurality of molding conditions by the injection molding machine injecting a plasticized material obtained by plasticizing the material into a mold under an environmental condition including the temperature and the humidity adjusted in (a) and the moisture content acquired in (b); and
(e) determining an optimum condition in the molding conditions under the environmental condition based on quality of the molded article molded in (d), wherein
in (a),
the temperature is adjusted to a temperature of a place where the molded article is to be produced, and
the humidity is adjusted to humidity of the place where the molded article is to be produced.

2. The molding condition setting method according to claim 1, wherein
in (c), a first molding condition and a second molding condition in which a first parameter, which is a parameter in the first molding condition, is different from that of the first molding condition are set, and
(d) includes
the injection molding machine molding a first molded article under the first molding condition, and
the injection molding machine molding a second molded article under the second molding condition, and
in (e), the optimum condition is selected from the first molding condition and the second molding condition according to a comparison result between the first molded article and the second molded article.

3. The molding condition setting method according to claim 1, wherein
the moisture content is measured by a spectrometer in (b).

4. The molding condition setting method according to claim 3, wherein
the spectrometer is disposed in a hopper in which the material is stored.

5. The molding condition setting method according to claim 1, further comprising:
(f) setting a set value of a factor that is adjusted according to the environmental condition and that is related to molding of the molded article, wherein
in (c), each of the molding conditions is set such that an effective value of the factor in (d) is close to the set value, and
the factor includes at least one of a temperature of the mold, a temperature of the plasticized material, a pressure of the plasticized material, an injection speed of the plasticized material, and a cooling time of the mold.

6. The molding condition setting method according to claim 5, wherein
(d) includes
monitoring the effective value, and
storing, in a storage unit, first information in which the environmental condition, the molding condition, and the effective value when the molded article is molded under the molding condition under the environmental condition are associated with one another.

7. The molding condition setting method according to claim 6, further comprising:
(g) molding the molded article under the optimum condition under the environmental condition by the injection molding machine, wherein
in (g), the optimum condition is corrected based on the first information when the effective value varies outside a predetermined range.
